(19) United States
(12) Patent Application Publication
(10) Pub. No.: US 2012/0110489 A1
(43) Pub. Date: May 3, 2012

(54) DYNAMIC LOADING OF DEVICE FEATURE SPECIFIC GRAPHICAL USER INTERFACE PRESENTATIONS

(75) Inventors: Kelly Huttelmaier, Mequon, WI (US); Michael Keller, Menomonee Falls, WI (US); Gregory W. Mears, Sussex, WI (US)

(73) Assignee: Rockwell Automation Technologies, Inc., Mayfield Heights, OH (US)

(21) Appl. No.: 13/032,353

(22) Filed: Feb. 22, 2011

Related U.S. Application Data
(60) Provisional application No. 61/408,481, filed on Oct. 29, 2010.

(51) Int. Cl. G06F 3/048

(52) U.S. Cl. 715/771

(57) ABSTRACT

A device in a machine automation environment is controlled by executing a primary software application to generate a primary graphical view of controls for the device, executing a secondary software application to generate a secondary graphical view of controls for the device, and displaying an integrated graphical view comprising the secondary graphical view integrated with the primary graphical view.

### RELATED APPLICATIONS

This application is related to and claims priority to U.S. Provisional Patent Application No. 61/408,481, entitled “Dynamic Loading of Device Feature Specific Graphical User Interface Presentations” filed on Oct. 29, 2010, which is hereby incorporated by reference in its entirety.

### TECHNICAL FIELD

The subject matter described herein is related to the field of industrial automation control products.

### TECHNICAL BACKGROUND

Industrial environments include automobile manufacturing factories, food processing plants, microprocessor fabrication facilities, and many other types of production and processing operations. The typical industrial environment includes various machines, such as pumps, drives, motors, and robots. Machines in industrial environments are commonly controlled by computers and software. Various types of software tools are used to configure, control, and monitor the machines. A typical installation includes multiple types of machines. It is often beneficial to have a single software interface for configuring, controlling, or monitoring several types of machines. A single interface is efficient and allows the activities of the machines to be coordinated and controlled in a centralized fashion. In many cases, this interface is implemented in the form of a graphical user interface (GUI).

Over time, the software may have to be updated because the needs of the industrial environment have changed. The needs of the industrial environment may change because production needs have changed, because opportunities for improvement have been identified, because machines with new capabilities are installed, or for other reasons. A software modification or update associated with one machine may require an update to the software which controls a group of machines because the control is consolidated into a single software application. Consequently, the entire software application may need to be modified, updated, or recompiled in response to a change which affects only one or a small number of the many machines.

### OVERVIEW

A device in a machine automation environment is controlled by executing a primary software application to generate a primary graphical view of controls for the device, executing a secondary software application to generate a secondary graphical view of controls for the device, and displaying an integrated graphical view comprising the secondary graphical view integrated with the primary graphical view.

### BRIEF DESCRIPTION OF THE DRAWINGS

FIG. 1 illustrates a configuration system.

FIG. 2 illustrates a method of operating a configuration system.

FIG. 3 illustrates a configuration system including controls for an old device and controls for a new device.

FIG. 4A illustrates a configuration system including device diagnostics.

FIG. 4B illustrates a configuration system including device diagnostics.

FIG. 5 illustrates a configuration system.

### DETAILED DESCRIPTION

The following description and associated drawings teach the best mode of the invention. For the purpose of teaching inventive principles, some conventional aspects of the best mode may be simplified or omitted. The following claims specify the scope of the invention. Some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

A GUI is often used for configuring, controlling, or monitoring machines in industrial automation environments. A single GUI associated with a primary software application is often used to control and coordinate the activities of multiple machines. The control features associated with one machine may need to be changed for one or more of several reasons including: the machine is being added to an already existing installation, the machine has been upgraded, the machine has been replaced, previously unused features of the machine are now being invoked, or for other reasons.

A software or configuration update associated with one machine may require an update to the primary software which controls a group of machines because the control functions are consolidated into the primary software application. Consequently, the primary software application may need to be modified, updated, or recompiled in response to a change associated with only one machine. Because the primary software application is being updated, there is risk of undesirable effects of the changes which may affect the operation or control of the other machines in unexpected ways. For this and other reasons, many or all aspects of the primary software application may have to be tested, reinstalled, reconfigured, or verified as a result of the changes associated with one machine. This situation may also result when a new machine is being added to an existing installation of machines which are being controlled or monitored by a centralized software application.

The problem of displaying added or changed machine-specific configurations in a GUI is often solved by one of two methods. The first method is to hard code machine specific parameters, knowledge, or configuration information into the primary software application so it can be properly displayed in the GUI. This requires that the primary software application contain the explicit details of these features as well as instructions on how to present this information to the user in the GUI. In this situation, any change to the control features of a single machine involves a change to the primary software application. A second approach is to define a standard mechanism for launching a top level machine GUI. These mechanism based solutions typically use a defined communication interface which must be implemented in each machine specific GUI. This approach distributes the communications with the machine across multiple applications and may lead to inconsistencies, conflicts, inter-application communication requirements, priority requirements, or other complications.

Described herein are systems, methods, and software for use in an industrial automation environment that provide for defining a model that supports dynamic loading of device feature specific GUI presentations for a diverse set of devices used in automated machine environments. The model is used in the context of a primary software application that provides a graphical user interface to program and configure devices. The model provides the ability to add GUI components for new devices and new device features without requiring modifications to the primary software application through use of a secondary software application.

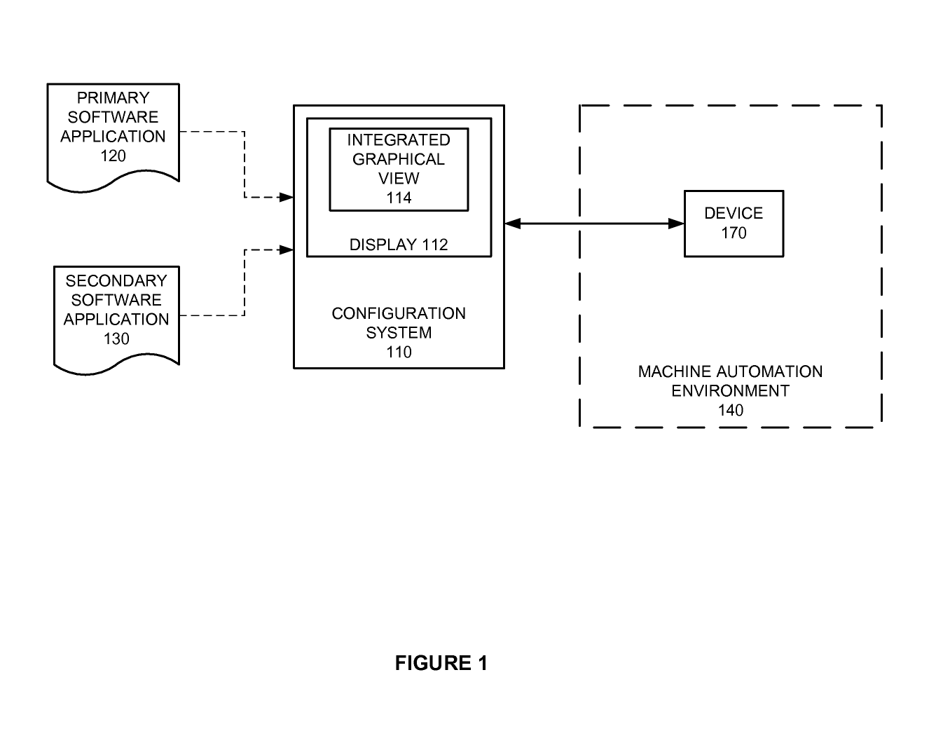

FIG. 1 illustrates configuration system 110 and its use to control a device in a machine automation environment. Configuration system 110 comprises display 112. Display 112 comprises integrated graphical view 114. Configuration system 110 executes primary software application 120 and secondary software application 130 to control device 170 in machine automation environment 140.

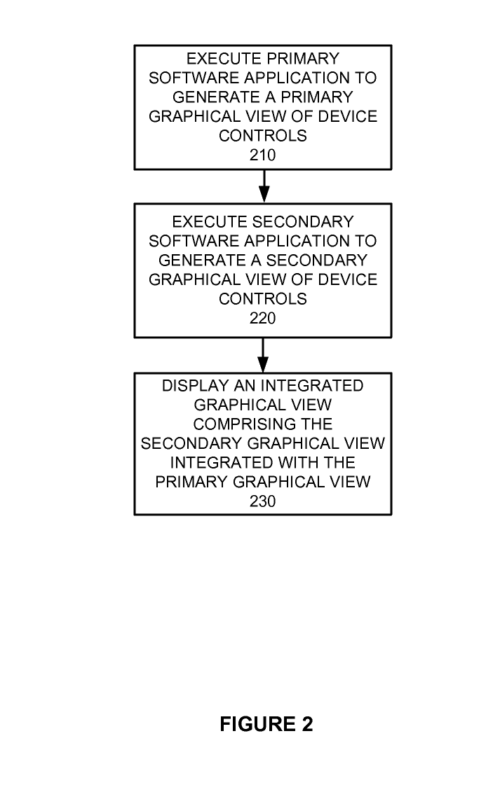

FIG. 2 illustrates an operation of configuration system 110. The steps of the operation are indicated below parenthetically. In order to control a device in a machine automation environment, configuration system 110 executes primary software application 120 to generate a primary graphical view of device controls (210). Configuration system 110 then executes secondary software application 130 to generate a secondary graphical view of device controls (220). Configuration system 110 then displays an integrated graphical view of the secondary graphical view integrated with the primary graphical view on display 112 (230).

Referring back to FIG. 1, configuration system 110 controls device 170 which operates in machine automation environment 140. Configuration system 110 comprises display 112. Configuration system 110 may also comprise other computing components including circuitry, a processor, memory, a communication interface, an input device, an output device, or other computing components, including combinations thereof. Configuration system 110 may comprise a computer, a server, a control system, or some other type of computing device, including combinations thereof.

Configuration system 110 executes primary software application 120 and secondary software application 130 in order to configure, control, monitor, or otherwise interface with device 170. Primary software application 120 and secondary software application 130 comprise the instructions and related data which, when executed by configuration system 110, enable a user to configure, control, monitor, or otherwise operate device 170. When executed, primary software application 120 and secondary software application 130 may display information to the user and allow the user to enter information or make selections regarding the operation of device 170.

Machine automation environment 140 is a manufacturing, production, or processing environment where devices are used to perform processes. Machine automation environment 140 may be in a factory, on a production line, in a repair facility, in a test system, or other similar type of environment.

Device 170 operates in machine automation environment 140 and communicates with configuration system 110 for control purposes, for monitoring purposes, or both. Device 170 may comprise a pump, a drive, a motor, a robot, an automated tool, a test instrument, or other automated device, including combinations thereof, for performing an operation in machine environment 140.

Display 112 is a device for visually or graphically presenting information to a user of configuration system 110. Display 112 displays information generated by configuration system 110. Display 112 may comprise a liquid crystal display (LCD), cathode ray tube (CRT), or other type of graphical display device.

Integrated graphical view 114 is a control interface for device 170 which appears as a GUI on display 112. Integrated graphical view 114 is generated when primary software application 120 and secondary software application 130 are executed by configuration system 110. Integrated graphical view 114 may include a dialog box, a drop down selection menu, radio button selection choices, an input field, a visual diagram, a list of options, or other means of allowing the user to input information regarding the configuration or operation of device 170. Integrated graphical view 114 may also include a status indicator, alert, graph, chart, diagram, or other means of representing information regarding the operational status of device 170.

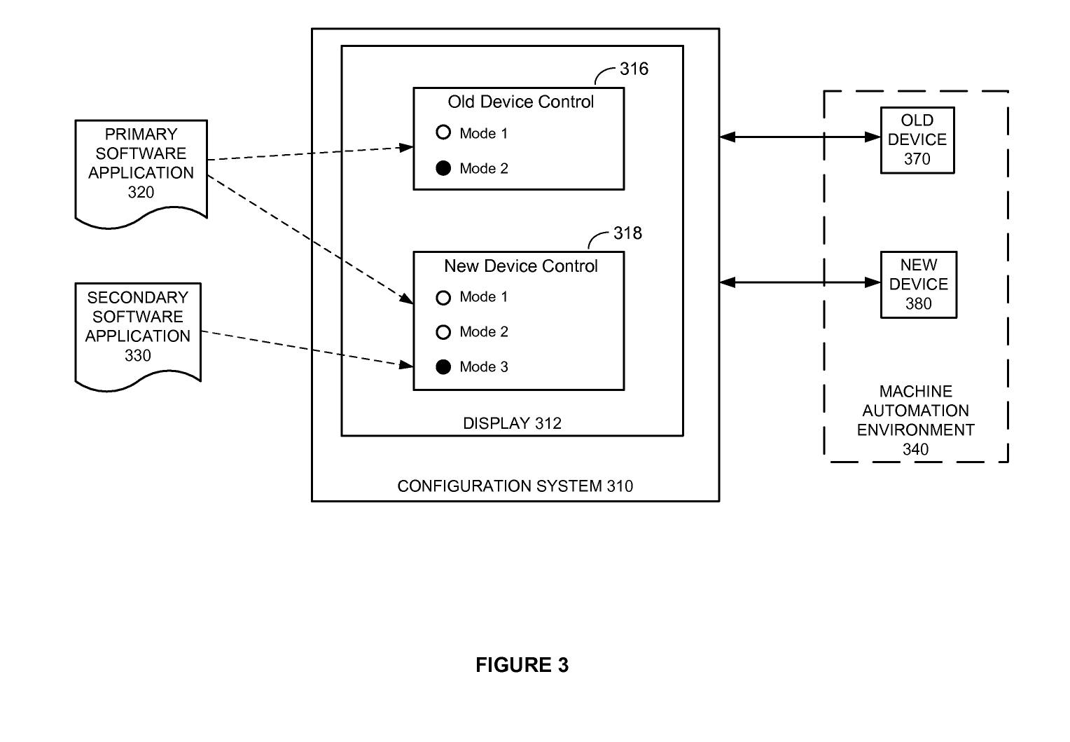

FIG. 3 illustrates configuration system 310 and its use to control devices in a machine automation environment. Configuration system 310 is an example of configuration system 110, although configuration system 310 may be implemented in alternate forms or may have alternate methods of operation. Configuration system 310 comprises display 312. Display 312 is an example of display 112, although display 312 may be implemented in alternate forms or may have alternate methods of operation.

Machine automation environment 340 is an example of machine automation environment 140, although machine automation environment 340 may exist in alternate forms or provide alternate functions. Machine automation environment 340 comprises old device 370 and new device 380.

Configuration system 310 executes primary software application 320 to generate graphical display window 316. Configuration system 310 executes primary software application 320 and secondary software application 330 to generate integrated graphical display window 318. Primary software application 320 is an example of primary software application 120, although primary software application 320 may be implemented in alternate forms or may have alternate methods of operation. Secondary software application 330 is an example of secondary software application 130, although secondary software application 330 may be implemented in alternate forms or may have alternate methods of operation. Configuration system 310 uses primary software application 320 and secondary software application 330 to interface with a user of configuration system 310 and generate control instructions for old device 370 and new device 380.

In one example of operation, configuration system 310 is used at one point in time to operate old device 370. In this example, old device 370 is a drive used in a manufacturing process in machine automation environment 340. In this example, machine automation environment 340 is a factory.

Configuration system 310 executes primary software application 320 in order to generate graphical display window 316. Graphical display window 316 enables a user of configuration system 310 to see the choice of modes of operation for the drive and to select from those modes. In this example, the user selects from mode 1 and mode 2 for the drive by selecting a radio button using an input device. Graphical display window 316 may also offer many other configuration choices, operation modes, and other options for the configuration or operation of the drive. Control signals are transmitted from configuration system 310 to the drive in order to instruct the drive to operate in the manner selected by the user.

Primary software application 320 is an executable file which is already compiled and may be executed by a processor in configuration system 310 without further parsing, interpretation, or compilation by another program. Because it is an executable program, the choices in graphical display window 316 appear the same way each time primary software application 320 is executed. In order to change the options available in graphical display window 316 or make additional options available, the software code which was used to generate primary software application 320 would have to be modified and recompiled to generate a new executable software application. This new executable software application would replace primary software application 320 and operate to make the modified or additional options available to the user.

At a different point in time, the operator of the factory desires to make use of another device in the factory, new device 380. In this example, new device 380 is a new drive. The new drive may be of a different make than the first drive, may be a different model than the first drive, or may have different features than the first drive. For any of these reasons, the new drive may have features, options, or characteristics which were not present in the old drive. In this example, the new drive has a third mode of operation, mode 3, which was not available in the first drive.

The user of configuration system 310 may wish to utilize mode 3 in order to more efficiently perform the manufacturing operations in the factory. However, graphical display window 316 does not contain the mode 3 option and would not enable a user to send the instruction to the new drive to operate in mode 3. Mode 3 may have not been included in primary software application 320 because it did not exist at the time the source code for primary software application 320 was written and compiled or it may have been left out of primary software application 320 for other reasons.

Given this situation, the source code for primary software application 320 would have to be modified and recompiled in order to generate a new software application which has this option. The new software application would have to replace primary software application 320 as portions of an executable software program typically cannot be modified without regenerating and replacing the entire program. Unfortunately, the nature of software and software modifications are such that a change to the software may also have unexpected, unintended, or undesirable effects. For this reason, a thorough test, evaluation, and verification process may have to be undertaken if primary software application 320 is modified. This can be an expensive and time consuming process as the software may have many different modes and features which have to be retested even though they were not the subject of, or related to, the particular modifications.

This situation also presents logistical problems for the users of the software. The users often do not have access to the source code nor the expertise or resources to generate a new executable file when they add a device or modify their manufacturing environment. As a result, the user would have to get the provider of the software to generate a new executable file containing the new options, modes, features, or characteristics.

However, the problems described above are resolved through use of primary and secondary software applications which each generate graphical views which can be integrated to appear as a single graphical view. Primary software application 320 is designed in such a manner that it generates graphical display window 316 when executed alone. In this case, it generates a GUI which gives the user the option of selecting between mode 1 and mode 2 for the first drive.

Primary software application 320 also contains features which allow it to integrate other control options into the display when they are available through a secondary software application. In this example, the new drive has the option of being operated in mode 3 in addition to the original modes 1 and 2 of the first drive. Secondary software application 330 is used to make the option of mode 3 available to the user without duplicating, recreating or replacing the features and functions of primary software application 320.

When executed alone, primary software application 320 generates graphical display window 316 which contains two mode choices. However, when primary software application 320 and secondary software application 330 are executed together, integrated graphical display window 318 containing three mode choices results. Primary software application 320 is designed in such a manner that it can be supplemented with additional options and additional graphical features when executed in conjunction with secondary software application 330. Integrated graphical display window 318 is the result of these two applications being executed simultaneously and is displayed to the user of configuration system 310 on display 312.

Although the primary and secondary software applications each contribute a separate portion of the options which are displayed and made available as choices, they are presented to the user in an integrated manner in the same input box or dialog box as single set of options or choices. Primary software application 320 is designed in a manner which allows the additional options contributed by secondary software application 330 to be integrated at the time of execution even though the details of the options which will be added by secondary software application 330 may not be known or available at the time primary software application 320 is written and compiled.

In this way, configuration system 310 may continue using primary software application 320 without replacing, modifying, or recompiling it but still get the benefit of new features, options, or modes which may be associated with new devices. This is of significant benefit for several reasons. Primary software application 320 may be large and have many features compared to the small incremental addition provided by secondary software application 330. Executable primary software application 320 can continue to be used without the risk, disruption, or logistical problems associated with changing the entire application being used to run the factory equipment. There is increased flexibility because new drives can be added without needing the primary software platform to be modified or recompiled by the software provider. Cost savings may also result from the approach described above.

In one variation, configuration system 310 searches a storage location when primary software application 320 is executed. The storage location is searched to locate and retrieve secondary software application 330. The search location may contain multiple versions of secondary software application 330 and configuration system 310 may be required to identify the most recent version of secondary software application 330 in order to determine the correct version to load.

In another variation, configuration system 310 executes multiple supplemental software applications like secondary software application 330. Each of the supplemental software applications generates a graphical view which is included in the integrated graphical view. In this way, what appears to the user to be a single dialog box may be composed of graphical view elements contributed by two or more supplemental executable software applications like secondary software application 330. The execution of secondary software application 330 may also cause the execution of additional software applications.

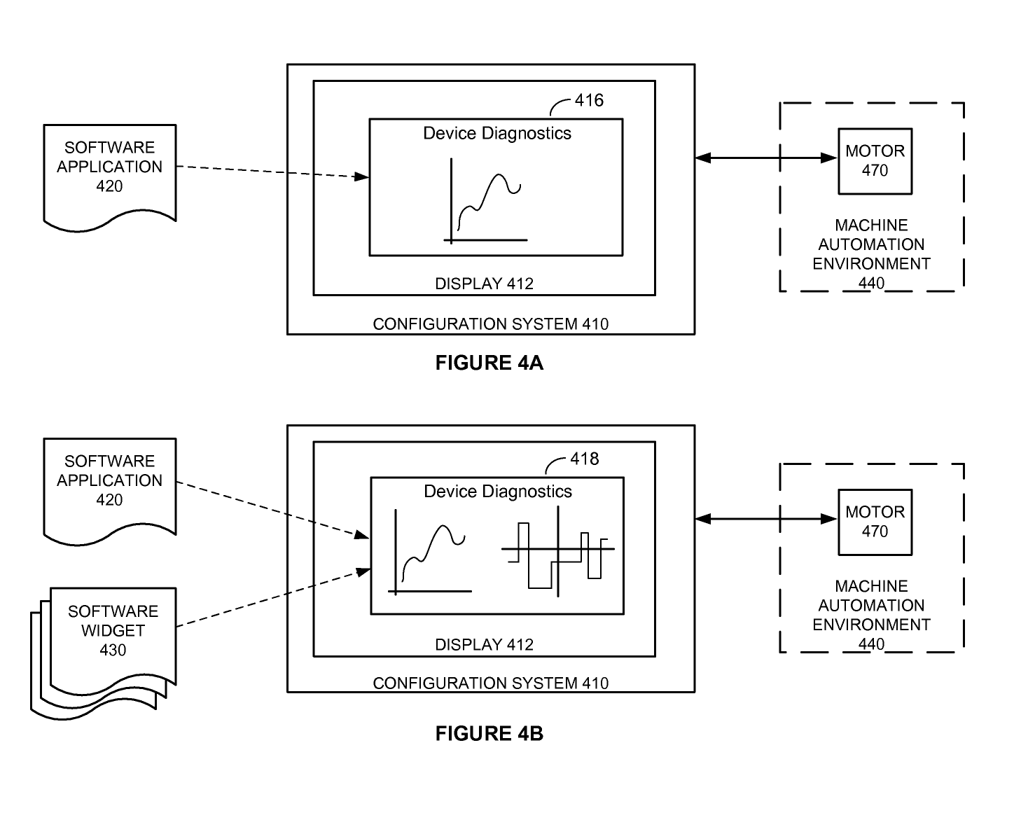

FIG. 4A and FIG. 4B illustrate configuration system 410 and its use to monitor devices in a machine automation environment at two different points in time. Configuration system 410 is an example of configuration systems 110 and 310, although configuration system 410 may be implemented in alternate forms or may have alternate methods of operation. Configuration system 410 comprises display 412. Display 412 is an example of displays 112 and 312, although display 412 may be implemented in alternate forms or may have alternate methods of operation.

Machine automation environment 440 is an example of machine automation environments 140 and 340, although machine automation environment 440 may exist in alternate forms or provide alternate functions. Machine automation environment 440 comprises motor 470. Motor 470 is any type of device for converting electrical energy into mechanical energy for use in factory equipment or to accomplish a step in a manufacturing process.

In FIG. 4A, configuration system 410 executes software application 420 to generate graphical display window 416. At a different time, in FIG. 4B, configuration system 410 executes software application 420 and software widget 430 to generate integrated graphical display window 418. Software application 420 is an example of primary software applications 120 and 320, although software application 420 may be implemented in alternate forms or may have alternate methods of operation. Software widget 430 is an example of secondary software applications 130 and 330, although software widget 430 may be implemented in alternate forms or may have alternate methods of operation. Configuration system 410 uses software application 420 and software widget 430 to interface with a user of configuration system 410 and enable interaction with motor 470. Multiple variations of software widget 430 may exist for a single device like motor 430. Configuration system 410 may select from these multiple variations of software widget 430 based on the status of motor 430 or based on some other factor.

In one example of operation of FIG. 4A, configuration system 410 is used to operate and monitor motor 470. Configuration system 410 executes software application 420 in order to generate graphical display window 416. Graphical display window 416 enables a user of configuration system 410 to see status or diagnostic information regarding the operation of motor 470. In this example, the user is able to view a graphical representation of an operational parameter of motor 470. This parameter could be a temperature, a speed, torque, loading, power consumption, or some other parameter, including combinations thereof. Graphical display window 416 may also offer many other monitoring, diagnostic, and configuration options for motor 470 or for other devices but only one is shown for purposes of clarity. Control signals are transmitted between configuration system 410 and motor 470 in order to obtain the diagnostic data.

Software application 420 is an executable file which is already compiled and may be executed by a processor in configuration system 410 without further parsing, interpretation, or compilation by another program. Because it is an executable program, the diagnostic display options in graphical display window 416 appear the same way each time software application 420 is executed. In order to change the available diagnostic displays in graphical display window 416 or make additional options available, the software code which was used to generate software application 420 would have to be modified and recompiled to generate a new executable software application. This new executable software application would replace software application 420 and operate to make the modified or additional diagnostic views available to the user.

At a different point in time, configuration system 410 is operated as illustrated in FIG. 4B. In this example, motor 470 is unchanged from FIG. 4A but additional diagnostic tools which were not available in software application 420 are now desired. However, graphical display window 416 does not contain the desired diagnostic view because the ability to display that type of view was not included in the code used to create software application 420.

Given this situation, the source code for software application 420 would typically have to be modified and recompiled in order to generate a new software application which has this new viewing option. The new software application would have to replace primary software application 420 as portions of an executable software program typically cannot be modified without regenerating and replacing the entire program. Unfortunately, the nature of software and software modifications is such that a change to the software may also have unexpected, unintended, or undesirable effects. For this reason, a thorough test, evaluation, and verification process may have to be undertaken every time a software modification takes place. This can be an expensive and time consuming process as the software may have many different modes and features which have to be retested even though they were not the subject of or related to the particular modifications.

This situation also presents logistical problems for the users of the software. The users often do not have access to the source code nor the expertise or resources to generate a new executable file when they want to add a new diagnostic tool or feature to the software. Consequently, the user would have to get the provider of the software to generate a new executable file containing the new diagnostic or display features.

However, the problem described above can be resolved through use of software widget 430 which generates a graphical view which can be integrated with the graphical view generated by primary software application 420 to appear as a single integrated graphical view. Software application 420 contains features which allow it to integrate other display options into the graphical display when they are available through use of a secondary software application, software widget 430. In this example, an integrated graphical view displays a first and a second diagnostic display where only the first diagnostic display was available without the use of software widget 430. In other words, software widget 430 is used to make the second diagnostic display available in integrated graphical display window 418 without duplicating, recreating or replacing the features and functions of software application 420.

Although each of software application 420 and software widget 430 contribute a separate portion of the diagnostic displays available in integrated graphical display window 418, they are presented to the user in an integrated manner in the window or screen. Software application 420 is designed in a manner which allows the additional features contributed by software widget 430 to be integrated at the time of execution even though the details of the features added by software widget 430 may not have been available or known at the time software application 420 was written and compiled.

In this way, configuration system 410 may continue using software application 420 without replacing, modifying, or recompiling it but still get the benefit of new features or display options. This may be of significant benefit for several reasons. Primary software application 420 may be quite large and have many features compared to the small incremental addition provided by software widget 430. Executable software application 420 can continue to be used without the risk, disruption, or logistical problems associated with changing the entire application being used to run the factory equipment. In addition, there is increased flexibility because features can be added without needing the primary software platform to be modified or recompiled by the provider of the primary software.

Software widget 430 may be implemented using the same or different tools than software application 420. Additional software tools may be used to store, manage, and select from available widgets. Each widget may have metadata which identifies the widget and indicates the types of devices and systems it is compatible with.

In one variation of the operation of configuration system 410, a user may be able to create software widget 430 even though software application 420 is provided by another party. In this situation, configuration system 410 may authenticate software widget 430 before it is executed. Widgets may also be created to assist in troubleshooting devices or for other technical support purposes.

In another variation of the operation of configuration system 410, multiple software widgets like software widget 430 may exist for motor 470 as illustrated in FIG. 4B. Each of these multiple software widgets may only be applicable or useful to certain states or modes of operation of the device. In this case, configuration system 410 will choose and load one or more of the multiple software widgets based on either the current state or mode of the device or the planned usage of the device.

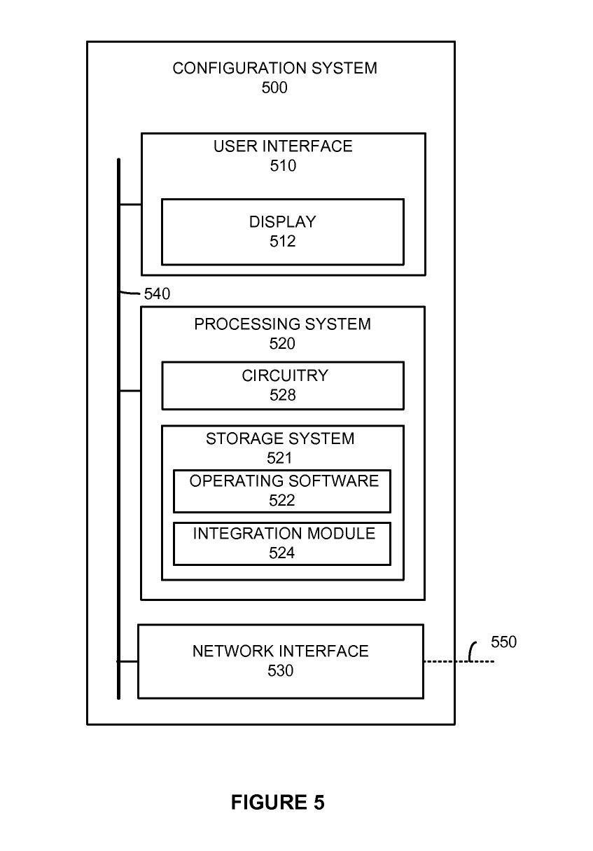

FIG. 5 illustrates an exemplary configuration system 500 in which the subject design may be implemented. Configuration system 500 includes user interface 510, processing system 520, and network interface 530. User interface 510, processing system 520, and network interface 530 communicate over bus 540. Configuration system 500 may be distributed among multiple devices that together form elements 510-550.

User interface 510 includes display 512 and components and circuitry for receiving user input and control. Examples of the equipment and circuitry for receiving user input and control include push buttons, touch screens, selection knobs, dials, switches, actuators, keys, keyboards, pointer devices, microphones, transducers, potentiometers, non-contact sensing circuitry, or other human-interface equipment. User interface 510 also includes equipment to communicate information to a user of configuration system 500. Examples of the equipment to communicate information to the user could include displays, indicator lights, lamps, light-emitting diodes, haptic feedback devices, audible signal transducers, speakers, buzzers, alarms, vibration devices, or other indicator equipment, including combinations thereof.

Processing system 520 includes circuitry 528 and storage system 521. Storage system 521 includes operating software 522 and integration module 524. Processing system 520 retrieves and executes operating software 522 from storage system 521. In some examples, processing system 520 is located within the same equipment in which user interface 510 or network interface 530 are located. In further examples, processing system 520 comprises specialized circuitry. Operating software 522 or storage system 521 could be included in the specialized circuitry to operate processing system 520 as described herein. Storage system 521 could include a computer-readable medium such as a disk, tape, integrated circuit, server, or some other memory device, and also may be distributed among multiple memory devices. Operating software 522 may include an operating system, logs, utilities, drivers, networking software, application software, widgets, and other software typically loaded onto a computer system. Storage system 521 may also optionally include the software applications and software widget illustrated in FIGS. 1, 3, 4A and 4B.

When executed by processing system 520, integration module 524 directs processing system 520 to operate as described herein for the operation of configuration system 500. Integration module 524 integrates the graphical view which result from execution of a primary and a secondary software application and the integrated view is displayed on display 512.

Network interface 530 comprises a network interface card, network transceiver and communication circuitry, wireline, optical, or wireless interfaces, or other communication equipment for communicating over network links. Network interface 530 exchanges communications with external systems, devices, human machine interfaces, controllers, or the like, over network link 550. Network link 550 comprises any link capable of carrying communications between network interface 530 and other external systems.

Bus 540 comprises a physical, logical, or virtual communication link, capable of communicating data, control signals, and communications, along with other information. In some examples, bus 540 is encapsulated within the elements of user interface 510, processing system 520, or network interface 530, and may be a software or logical link. In other examples, bus 540 uses various communication media, such as air, space, metal, optical fiber, or some other signal propagation path, including combinations thereof. Bus 540 could be a direct link or might include various equipment, intermediate components, systems, and networks.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of controlling a device in a machine automation environment comprising:
executing a primary software application to generate a primary graphical view of controls for the device;
executing a secondary software application to generate a secondary graphical view of controls for the device; and
displaying an integrated graphical view comprising the secondary graphical view integrated with the primary graphical view.

2. The method of claim 1 further comprising:
receiving a user selection from the integrated graphical view; and
transmitting control information based on the user selection for delivery to the device.

3. The method of claim 1 further comprising:
monitoring a status of the device;
selecting the secondary software application from a plurality of software applications based on the status of the device; and
integrating the status into the integrated graphical view.

4. The method of claim 1 further comprising:
modifying the secondary software application;
executing the modified secondary software application to generate a modified secondary graphical view of controls for the device; and
displaying an integrated graphical view comprising the modified secondary graphical view integrated with the primary graphical view.

5. The method of claim 1 wherein the primary software application and the secondary software application are executable software applications.

6. The method of claim 1 wherein the integrated graphical view comprises a single dialog box.

7. The method of claim 1 wherein the primary graphical view of controls is compatible with more than one type of device.

8. The method of claim 1 further comprising:
searching a storage location to locate the secondary software application; and
loading the secondary software application.

9. A configuration system for controlling a device in a machine automation environment comprising:
software stored on a non-transitory storage medium comprising a primary software application and a secondary software application;
a processing system configured to execute the primary software application to generate a primary graphical view of controls for the device and execute the secondary software application to generate a secondary graphical view of controls for the device; and
a display system configured to display an integrated graphical view comprising the secondary graphical view integrated with the primary graphical view.

10. The configuration system of claim 9 wherein the processing system is further configured to:
receive a user selection from the integrated graphical view; and
transmit control information based on the user selection for delivery to the device.

11. The configuration system of claim 9 wherein the processing system is further configured to:
monitor a status of the device;
select the secondary software application from a plurality of software applications based on the status of the device; and
integrate the status into the integrated graphical view.

12. The configuration system of claim 9 wherein the secondary software application is modified without modifying the primary software application.

13. The configuration system of claim 9 wherein the primary software application and the secondary software application are executable software applications.

14. The configuration system of claim 9 wherein the integrated graphical view comprises a single dialog box.

15. The configuration system of claim 9 wherein the primary graphical view of controls is compatible with more than one type of device.

16. A non-transitory computer readable medium having program instructions stored thereon that, when executed by a configuration system, direct the configuration system to:
execute a primary software application to generate a primary graphical view of controls for a device operating in a machine automation environment;
execute a secondary software application to generate a secondary graphical view of controls for the device; and
display an integrated graphical view comprising the secondary graphical view integrated with the primary graphical view.

17. The non-transitory computer readable medium of claim 16 wherein the program instructions further direct the configuration system to:
receive a user selection from the integrated graphical view; and
transmit control information based on the user selection for delivery to the device.

18. The non-transitory computer readable medium of claim 16 wherein the program instructions further direct the configuration system to:
monitor a status of the device;
select the secondary software application from a plurality of software applications based on the status of the device; and
integrate the status into the integrated graphical view.

19. The non-transitory computer readable medium of claim 16 wherein the program instructions further direct the configuration system to:
execute a modified version of the secondary software application to generate a modified secondary graphical view of controls for the device; and
display an integrated graphical view comprising the modified secondary graphical view integrated with the primary graphical view.

20. The non-transitory computer readable medium of claim 16 wherein the integrated graphical view comprises a single dialog box.
